(19) United States
(12) Patent Application Publication
(10) Pub. No.: US 2021/0172359 A1
(43) Pub. Date: Jun. 10, 2021

(54) High Conductive Exhaust Components for Deposit Prevention & Mitigation

(71) Applicant: Cummins Emission Solutions Inc., Columbus, IN (US)

(72) Inventors: Samuel Johnson, Bloomington, IN (US); Stephen M. Holl, Columbus, IN (US); Matthew K. Volmerding, Columbus, IN (US); Timothy Paul Meyer, Columbus, IN (US); Andrew J. Albers, Columbus, IN (US); Shashank Mishra, Cincinnati, OH (US)

(73) Assignee: Cummins Emission Solutions Inc., Columbus, IN (US)

(21) Appl. No.: 16/770,905

(22) PCT Filed: Dec. 15, 2017
(86) PCT No.: PCT/US2017/066678

§ 371 Date: Jun. 8, 2020

(51) Int. Cl. F01N 3/20; F01N 3/28

(52) U.S. Cl. CPC F01N 3/208; F01N 3/2807; F01N 3/2825; F01N 3/28

(57) ABSTRACT

A decomposition reactor tube (DRT) for converting a reductant into ammonia includes an internal structure including a high-thermal conductivity material having a thermal conductivity greater than 20 W/(m·K), wherein the internal structure is at least one of the splash plate, a splash plate frame, a double wall, an outer wall, a mixer, and/or an exhaust assist port.

### TECHNICAL FIELD

The present application relates generally to the field of aftertreatment systems for internal combustion engines.

### BACKGROUND

Decomposition chambers or reactor pipes (i.e., decomposition reactor tubes, DRTs) have been broadly used in aftertreatment systems to convert a reductant, such as urea, aqueous ammonia, or diesel exhaust fluid (DEF), into ammonia. Typically in fluid communication with a reductant delivery system, decomposition chambers receive reductants from the reductant delivery system through an inlet and output at least the ammonia and/or any remaining reductant though an outlet. Current DRT technology includes only internal steel geometries, which due to their physical, mechanical, and thermal properties (e.g., thermal conductivity, thermal diffusivity, etc.), suffer from excessive impingement and formation of DEF deposits. Specifically, low thermal conductivities of stainless steel materials result in surface temperatures of the DRT internal structure dropping below critical thresholds at DEF impingement locations, thereby enabling deposit formation.

### SUMMARY

Implementations described herein relate to a decomposition reactor tube (DRT) for converting a reductant into ammonia, comprising: an internal structure including a high-thermal conductivity material having a thermal conductivity greater than 20 W/(m·K), wherein the internal structure is at least one of a splash plate, a splash plate frame, a double wall, an outer wall, a mixer, and/or an exhaust assist port.

In one implementation, the high-thermal conductivity material has a thermal conductivity of at least 100 W/(m·K).

In one implementation, the high-thermal conductivity material has a thermal diffusivity greater than 4.7 mm²·sec⁻¹.

In one implementation, the high-thermal conductivity material has a thermal diffusivity of at least 50 mm²·sec⁻¹.

In one implementation, the high-thermal conductivity material has a yield strength of at least 300 MPa and a heat capacity of at least 700 J/kg·K.

In one implementation, the high-thermal conductivity material is chemically inert to diesel exhaust fluid (DEF) and urea-based compounds.

In one implementation, the high-thermal conductivity material is comprises at least one of a ceramic material and/or a metal alloy material.

In one implementation, the high-thermal conductivity material comprises at least one ceramic material selected from the group consisting of silicon carbide, aluminum nitride, and/or pyrolytic graphite.

In one implementation, the high-thermal conductivity material comprises a metal alloy material selected from the group consisting of an aluminum alloy, a magnesium-scandium alloy, and/or an aluminum-silicon-manganese-magnesium alloy.

In one implementation, the internal structure is at a temperature of at least 130° C.

In one implementation, the internal structure includes a hydrophobic surface coating.

In one implementation, the hydrophobic surface coating comprises micro-features and/or nano-features on at least a portion of the internal structure of the DRT.

In one implementation, the internal structure is a polished internal structure, a buffed internal structure, or a combination thereof.

In another implementation, a method of using a decomposition reactor tube (DRT), comprises: (a) injecting diesel engine fluid (DEF) into the DRT; (b) impinging the DEF at an impinging location of an internal structure of the DRT, the impinging location being at a pre-impingement temperature and the DEF being at a first temperature less than the pre-impingement temperature; (c) conductively transferring heat energy from the impinging location to the impinged DEF such that the DEF reaches a second temperature greater than the first temperature; and (d) evaporating the impinged DEF from the impinging location of the DRT, wherein the internal structure comprises a high-thermal conductivity material having a thermal conductivity greater than 20 W/(m·K).

In one implementation, the high-thermal conductivity material has a thermal conductivity of at least 100 W/(m·K).

In one implementation, the high-thermal conductivity material has a thermal diffusivity greater than 4.7 mm²·sec⁻¹.

In one implementation, the high-thermal conductivity material has a thermal diffusivity of at least 50 mm²·sec⁻¹.

In one implementation, the high-thermal conductivity material has a yield strength of at least 300 MPa and a heat capacity of at least 700 J/kg·K.

In one implementation, the high-thermal conductivity material comprises at least one of a ceramic material and/or a metal alloy material.

In one implementation, the high-thermal conductivity material comprises at least one ceramic material selected from the group consisting of silicon carbide, aluminum nitride, and/or pyrolytic graphite.

In one implementation, the high-thermal conductivity material comprises a metal alloy material selected from the group consisting of an aluminum alloy, a magnesium-scandium alloy, and/or an aluminum-silicon-manganese-magnesium alloy.

In one implementation, the method further comprises applying a hydrophobic surface coating to the internal structure prior to the step of impinging the DEF.

In one implementation, the step of applying includes forming micro-features and/or nano-features on at least a portion of the internal structure of the DRT.

In one implementation, the method further comprises polishing and/or buffing the internal structure prior to the step of impinging the DEF.

In one implementation, the pre-impingement temperature is at least 130° C.

### BRIEF DESCRIPTION

The details of one or more implementations are set forth in the accompanying drawings and the description below. Other features, aspects, and advantages of the disclosure will become apparent from the description, the drawings, and the claims, in which:

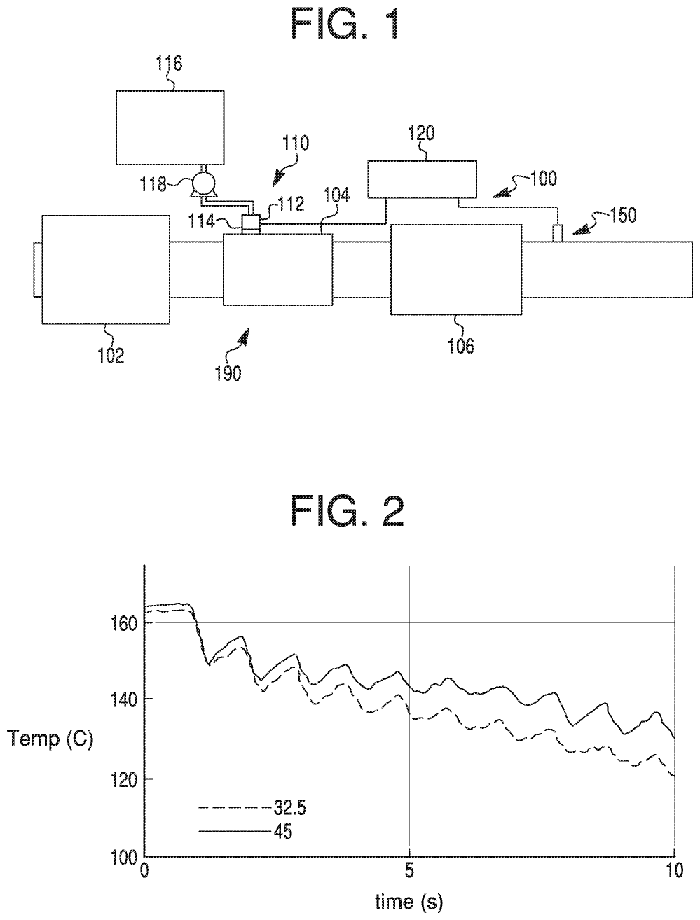

FIG. 1 is a block schematic diagram of an example selective catalytic reduction system having an example reductant delivery system for an exhaust system;

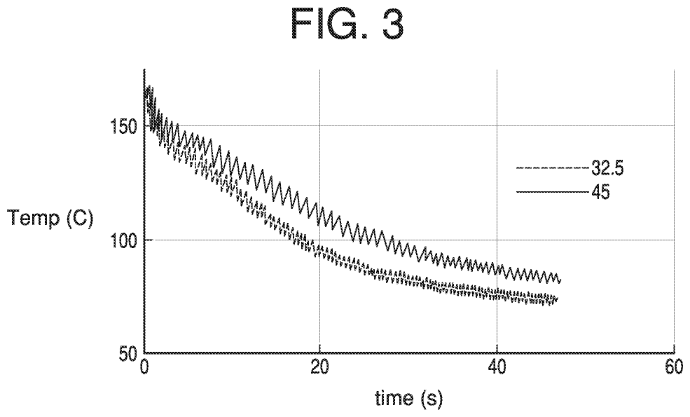

FIGS. 2 and 3 are temperature versus time plots of DEF-impinged stainless steel surfaces of a DRT after 10 seconds (FIG. 2) and 60 seconds (FIG. 3);

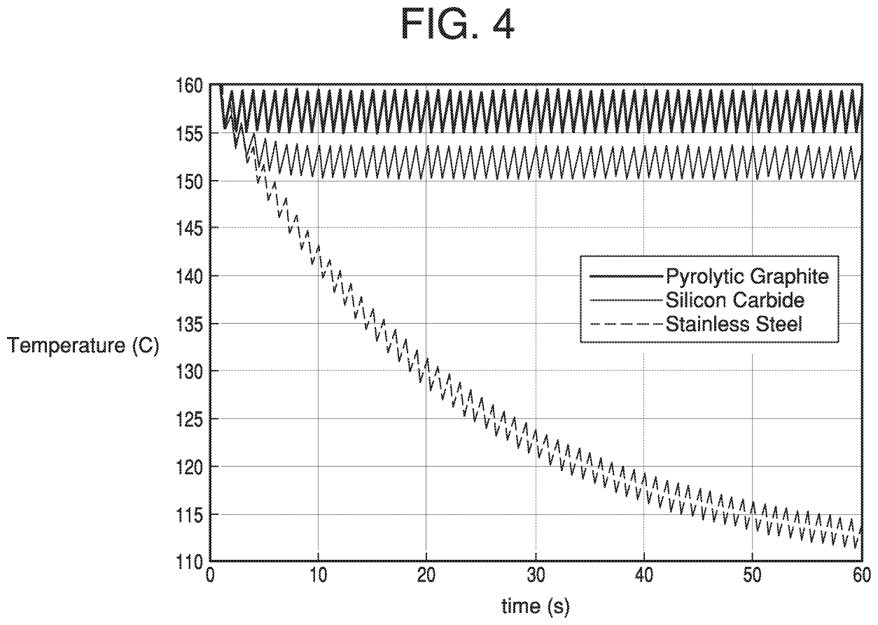

FIG. 4 is a simulated temperature versus time plot of a (i) DEF-impinged stainless steel DRT surface, (ii) DEF-impinged pyrolytic graphite surface, and (iii) DEF-impinged silicon carbide surface after 60 seconds; and

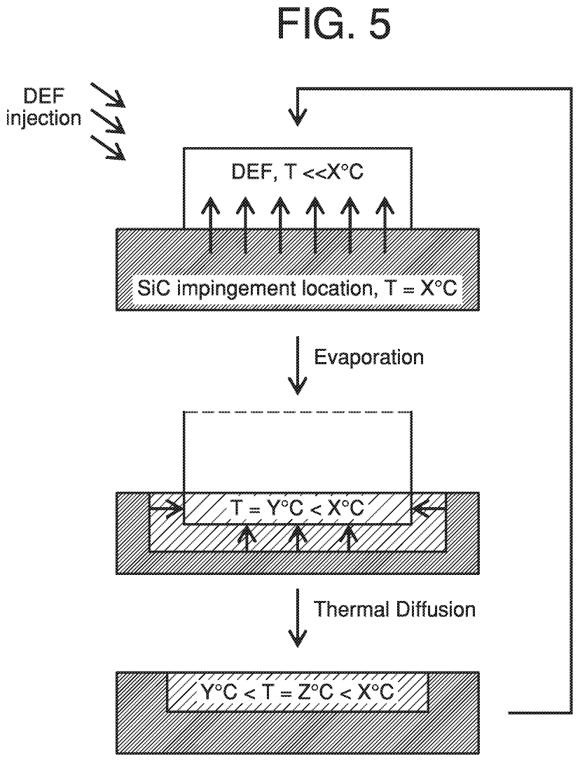

FIG. 5 is a flowchart of a DEF evaporation process using silicon carbide internal structure surfaces.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for aftertreatment of internal combustion engines. The various concepts introduced above and discussed in greater detail below may be implemented in any of numerous ways, as the described concepts are not limited to any particular manner of implementation. Examples of specific implementations and applications are provided primarily for illustrative purposes. Embodiments described herein can result in benefits such as providing an improved diesel particulate filter for diesel engines that overcomes the challenges described above. These and other advantageous features will be apparent to those reviewing the present disclosure.

### Overview

In some exhaust systems, a sensor module may be located downstream of a selective catalytic reduction (SCR) catalyst to detect one or more emissions in the exhaust flow after the SCR catalyst. For example, a NOₓ sensor, a CO sensor, and/or a particulate matter sensor may be positioned downstream of the SCR catalyst to detect NOₓ, CO, and/or particulate matter within the exhaust gas exiting the exhaust of the vehicle. Such emission sensors may be useful to provide feedback to a controller to modify an operating parameter of the aftertreatment system of the vehicle. For example, a NOₓ sensor may be utilized to detect the amount of NOₓ exiting the vehicle exhaust system and, if the NOₓ detected is too high or too low, the controller may modify an amount of reductant delivered by a dosing module. A CO sensor and/or a particulate matter sensor may also be utilized.

### Overview of Aftertreatment System

FIG. 1 depicts an aftertreatment system 100 having an example reductant delivery system 110 for an exhaust system 190. The aftertreatment system 100 includes a particulate filter, for example a DPF 102, the reductant delivery system 110, a decomposition chamber or reactor pipe 104, a SCR catalyst 106, and a sensor 150.

The DPF 102 is configured to remove particulate matter, such as soot, from exhaust gas flowing in the exhaust system 190. The DPF 102 includes an inlet, where the exhaust gas is received, and an outlet, where the exhaust gas exits after having particulate matter substantially filtered from the exhaust gas and/or converting the particulate matter into carbon dioxide.

The decomposition chamber 104 is configured to convert a reductant, such as urea, aqueous ammonia, or diesel exhaust fluid (DEF), into ammonia. The decomposition chamber 104 includes a reductant delivery system 110 having a dosing module 112 configured to dose the reductant into the decomposition chamber 104. In some implementations, the reductant is injected upstream of the SCR catalyst 106. The reductant droplets then undergo the processes of evaporation, thermolysis, and hydrolysis to form gaseous ammonia within the exhaust system 190. The decomposition chamber 104 includes an inlet in fluid communication with the DPF 102 to receive the exhaust gas containing NOₓ emissions and an outlet for the exhaust gas, NOₓ emissions, ammonia, and/or remaining reductant to flow to the SCR catalyst 106.

The decomposition chamber 104 includes the dosing module 112 mounted to the decomposition chamber 104 such that the dosing module 112 may dose the reductant into the exhaust gases flowing in the exhaust system 190. The dosing module 112 may include an insulator 114 interposed between a portion of the dosing module 112 and the portion of the decomposition chamber 104 to which the dosing module 112 is mounted. The dosing module 112 is fluidly coupled to one or more reductant sources 116. In some implementations, a pump 118 may be used to pressurize the reductant from the reductant source 116 for delivery to the dosing module 112.

The dosing module 112 and pump 118 are also electrically or communicatively coupled to a controller 120. The controller 120 is configured to control the dosing module 112 to dose reductant into the decomposition chamber 104. The controller 120 may also be configured to control the pump 118. The controller 120 may include a microprocessor, an application-specific integrated circuit (ASIC), a field-programmable gate array (FPGA), etc., or combinations thereof. The controller 120 may include memory which may include, but is not limited to, electronic, optical, magnetic, or any other storage or transmission device capable of providing a processor, ASIC, FPGA, etc. with program instructions. The memory may include a memory chip, Electrically Erasable Programmable Read-Only Memory (EEPROM), erasable programmable read only memory (EPROM), flash memory, or any other suitable memory from which the controller 120 can read instructions. The instructions may include code from any suitable programming language.

The SCR catalyst 106 is configured to assist in the reduction of NOₓ emissions by accelerating a NOₓ reduction process between the ammonia and the NOₓ of the exhaust gas into diatomic nitrogen, water, and/or carbon dioxide. The SCR catalyst 106 includes inlet in fluid communication with the decomposition chamber 104 from which exhaust gas and reductant is received and an outlet in fluid communication with an end of the exhaust system 190.

The exhaust system 190 may further include an oxidation catalyst, for example a diesel oxidation catalyst (DOC), in fluid communication with the exhaust system 190 (e.g., downstream of the SCR catalyst 106 or upstream of the DPF 102) to oxidize hydrocarbons and carbon monoxide in the exhaust gas.

In some implementations, the DPF 102 may be positioned downstream of the decomposition chamber or reactor pipe 104. For instance, the DPF 102 and the SCR catalyst 106 may be combined into a single unit, such as a DPF with SCR-coating (SDPF or SCRF). In some implementations, the dosing module 112 may instead be positioned downstream of a turbocharger or upstream of a turbocharger.

The sensor 150 may be coupled to the exhaust system 190 to detect a condition of the exhaust gas flowing through the exhaust system 190. In some implementations, the sensor 150 may have a portion disposed within the exhaust system 190, such as a tip of the sensor 150 may extend into a portion of the exhaust system 190. In other implementations, the sensor 150 may receive exhaust gas through another conduit, such as a sample pipe extending from the exhaust system 190. While the sensor 150 is depicted as positioned downstream of the SCR catalyst 106, it should be understood that the sensor 150 may be positioned at any other position of the exhaust system 190, including upstream of the DPF 102, within the DPF 102, between the DPF 102 and the decomposition chamber 104, within the decomposition chamber 104, between the decomposition chamber 104 and the SCR catalyst 106, within the SCR catalyst 106, or downstream of the SCR catalyst 106. In addition, two or more sensor 150 may be utilized for detecting a condition of the exhaust gas, such as two, three, four, five, or six sensors 150, with each sensor 150 located at one of the foregoing positions of the exhaust system 190.

### Decomposition Chamber Ceramic Materials

As explained above, decomposition chambers (i.e., decomposition reactor tubes, DRTs) of engine aftertreatment systems are configured to convert a reductant (e.g., urea, aqueous ammonia, or diesel exhaust fluid (DEF)) into ammonia. A reductant delivery system is configured to dose the reductant into the decomposition chamber. The decomposition chamber also includes an inlet in fluid communication with the DPF to receive the exhaust gas containing NOₓ emissions and an outlet for the exhaust gas, NOₓ emissions, ammonia, and/or remaining reductant to flow to the SCR catalyst.

At high engine speeds and load (i.e., torque output) a high flow capacity aftertreatment is required and thus, a high flow velocity through the DRT. At low engine speeds and load, exhaust temperature and flow velocity through the DRT reduces drastically and as a result, DEF deposits on internal structure of the DRT (e.g., splash plates, splash plate frames, double walls, outer walls, mixers, exhaust assist ports, etc.). Mechanistically, when DEF impinges on a surface at elevated temperatures, it will absorb energy via heat transfer at the impinging location, and thereby evaporate from the surface. As a result of this heat transfer to and evaporation of the DEF, a cold spot is created at the impinged location and is more susceptible to DEF deposition in a subsequent impingement for conventional stainless steel internal geometries. At low temperatures and flow velocities, steel internal geometries are not able to recover heat fast enough at the impinged locations and eventually, deposit formation begins. Stainless steel grades incur excessive thermal resistance and therefore, heat from non-wetted surfaces (i.e., those that do not experience DEF impingement) is not able to sufficiently transfer to the wetted surfaces before the next impingement occurs. Because of this diminished capacity for transferring thermal energy to the impinged location, after multiple injections, the surface temperatures of impingement locations drop below a critical threshold such that over time, there is a lack of sufficient heat energy at the impinged location to transfer to the impinged DEF, resulting in unwanted DEF deposits, which have a decomposition temperature, T_{crit, urea decomp.}, of at least about 130° C.

FIGS. 2 and 3 are temperature versus time plots of DEF-impinged stainless steel surfaces of a DRT after 10 seconds (FIG. 2) and 60 seconds (FIG. 3). In both FIGS. 2 and 3, a thermocouple was positioned in a location where wetting is most susceptible and testing was conducted for two separate feed concentrations of DEF (32.5% DEF and 45% DEF). Starting with an internal structure temperature in a range of about 165° C. to 170° C., within 10 seconds, the surface temperature of the DRT at locations experiencing high levels of DEF impingement decreased to about 120° C. for a 32.5% DEF feed concentration and about 130° C. for a 45% DEF feed concentration (FIG. 2).

At longer intervals of about 50-60 seconds, the temperature decline is even more pronounced, decreasing to well below the critical temperature for DEF decomposition (T_{crit, urea decomp.} ˜130° C.) above which, impinging DEF is able to evaporate from the impinged surface. For example, at a 32.5% DEF feed concentration, the surface temperature of the impinged stainless steel surface decreased to approximately 75° C. and for a 45% DEF feed concentration, surface temperature decreased to approximately 85-90° C. (FIG. 3). Moreover, after about 20-30 seconds, depending on the amount of DEF in the feed, surface temperatures for stainless steel DRT internal geometries are below the evaporation temperature of water (100° C.), which is a component of the reductant received by the DRT for conversion (e.g., DEF is an aqueous urea solution comprising about 32.5% urea and about 67.5% water). As a result of this DEF and potentially water buildup, engine fuel economy declines.

The present application discloses high thermal conductivity ceramics for use in an internal structure of a DRT that allows for sufficient transfer of heat from non-wetted regions to wetted regions in order to maintain high temperatures and prevent deposition of DEF. At low engine speeds and load, wetted internal geometries remain at sufficient elevated temperatures to allow for continuous evaporation of DEF. Thus, as presented herein, the disclosed ceramics have high thermal conductivities (e.g., at least 100 W/(m·K)), high thermal diffusivity (e.g., at least 50 mm²·sec⁻¹), are chemically inert to diesel exhaust fluid (DEF) and urea-based compounds (e.g., decomposition byproducts of urea), have high resistance to thermal shock and a high melting point. In one embodiment, the ceramic material also has high strength (e.g., yield strength of at least 300 MPa) and a specific heat capacity of at least 700 J/kg·K. In one implementation, the ceramic material is silicon carbide, aluminum nitride, or pyrolytic graphite. According to some embodiments, the high-thermal conductivity material has a thermal conductivity greater than 20 W/(m·K) or greater than 40 W/(m·K) or greater than 60 W/(m·K) or greater than 80 W/(m·K) or greater than 100 W/(m·K).

According to some embodiments, the high-thermal conductivity material may be a metal alloy material selected from at least one of aluminum alloys (e.g., 6061-T6, thermal diffusivity, α˜64 mm²/sec), magnesium-scandium alloys (e.g., MgSc₄, α˜40 mm²/sec), or aluminum-silicon-manganese-magnesium alloys (e.g., Silafont® 36, α˜74 mm²/sec).

In one exemplary embodiment, temperature continuities of a DEF-impinged silicon carbide surface and a DEF-impinged pyrolytic graphite surface were compared against a DEF-impinged stainless steel DRT surface after 60 seconds (FIG. 4). In FIG. 4, data was collected assuming (1) a constant heat flux out of the local wall location (i.e., the impinged location) for 0.5 second and (2) a low constant energy into impinged location from the exhaust for 0.5 second. Thus, the only variable in impinging conditions is the thermal material property differences between stainless steel and silicon carbide and pyrolytic graphite, summarized in Table 1.

TABLE 1

| | Thermal | | Heat | Thermal |
|---|---|---|---|---|
| | conductivity, | Density, | Capacity, | Diffusivity, |
| | K | ρ | Cₚ | α |
| Material | (W/(m · K)) | (kg/m³) | (J/kg/K) | (mm²/sec) |
| Stainless steel | 20 | 7700 | 500 | 4.7 |
| Silicon carbide | 120 | 3100 | 750 | 52 |
| Pyrolytic graphite | 400 | 2200 | 712 | 255 |

As is seen in FIG. 4, the silicon carbide (SiC) surface is able to equilibrate at a temperature (about 150° C.) much higher than the stainless steel (about 110° C. to 115° C. after 60 seconds) and in a much shorter time period (about 5 seconds); pre-impingement conditions of both the stainless steel and silicon carbide surfaces were set at about 160° C. In fact, even after 60 seconds, there is no thermal equilibration observed for the stainless steel at 110° C. to 115° C. Similar temperature trends may be obtained anywhere DEF impingement is occurring after every injection. Thus, the change in surface temperature for stainless steel is much more drastic (Δ50-55° C.) than for silicon carbide (Δ10° C.) after 60 seconds. Pyrolytic graphite surfaces equilibrate at an even higher temperature than silicon carbide (about 155° C.) almost immediately without any lag time, thereby making the differences seen between stainless steel and silicon carbide even more pronounced when stainless steel is compared to pyrolytic graphite.

While mechanistically DEF has the same effect on a stainless steel surface as on a silicon carbide surface (i.e., impinging DEF absorbs thermal energy from the impinged surface and evaporates from the surface, thereby resulting in a cold spot at the impinged location), silicon carbide allows for recovery of the cold spot to near pre-impingement conditions in a shorter period of time. Equilibrium temperature is affected by a combination of factors including (1) the initial convection rate of heat transfer from the exhaust flow to the DEF, (2) the initial conduction rate of heat transfer from the impinged location to the DEF, (3) the interface size between a “hot” surface (non-impinged location) and an adjacent cold spot (as determined by the size and shape of the impinging body) after evaporation, and (4) the difference in temperature between the exhaust flow and the wetted surface. High conductive ceramic materials are preferable over stainless steel because they are able to increase conduction rates of heat transfer between the DEF and impinged location due to higher thermal conductivities (Table 1) (i.e., greater than 20 W/(m·K)) and rapidly shrink interface sizes between a hot, non-impinged location and an adjacent cold spot after evaporation.

One important parameter characterizing the difference in performance in stainless steel and silicon carbide (and similar situated compounds such as aluminum nitride or pyrolytic graphite) materials is thermal diffusivity, defined as

$$α = \frac{K}{ρ Cp} ,$$

where K is thermal conductivity, p is material density, and Cₚ is heat capacity (see Table 1), and practically, is the ability of a material to conduct heat relative to its thermal storage. Using the inputs of each parameter from Table 1, silicon carbide is calculated to have a higher thermal diffusivity as a result of a thermal conductivity six times that of stainless steel (20 W/(m·K) for stainless steel versus 120 W/(m·K) for silicon carbide). Thus, because of the elevated thermal conductivity of silicon carbide (and related materials such as aluminum nitride and pyrolytic graphite), thermal diffusivity of these materials is also greater than that of stainless steel, meaning that stored thermal energy is more quickly transferred to the DEF impingement zone and lost thermal energy (as measured by temperature) is more quickly restored to near pre-impingement conditions (see FIG. 4). In other words, diffusive materials such as silicon carbide, aluminum nitride, and pyrolytic graphite enable high heat transfer within the material by utilizing heat energy from the volume of the structure to heat the impinged location, reducing cumulative temperature drop, and decreasing the time to re-heat the impinged surface. Moreover, diffusive materials may help to maintain surface temperatures in recirculation zones where impingement and droplet condensation is highly likely.

FIG. 5 is a flowchart of a DEF evaporation process using silicon carbide internal structure surfaces. As explained above and shown in FIG. 5, after DEF is injected into the decomposition reactor tube, it impinges along a silicon carbide surface of the DRT at a temperature much lower than the surface itself. In one exemplary embodiment, the SiC surface is at a temperature in a range of 160° C. to 170° C. at pre-impingement conditions and the impinged DEF is at a temperature in a range of 60° C. to 70° C. After the impinged DEF acquires a sufficient amount of energy as a result of convective heat transfer from the exhaust flow of the DRT and conductive heat transfer from the SiC surface, the impinged DEF evaporates from the SiC surface and creates a cold spot whereby the impinged location is at a temperature (i.e., Y° C.) lower than the pre-impingement state (i.e., X° C.). The cold evaporative process creates an interface between a hot, non-impinged surface still at the pre-impingement temperature, and a cold spot where the DEF had previously impinged. Because of a high thermal conductivity, and therefore, a high thermal diffusivity, the silicon carbide material is able to rapidly shrink interface sizes and achieve near pre-impingement conditions at the cold spot. Thus, prior to a subsequent DEF injection, the impinged locations stabilizes at a temperature Z above the temperature of the cold spot immediately after evaporation (Y° C.), but lower than the temperature at pre-impingement conditions (X° C.). In one exemplary embodiment, temperature Z may be at least 150° C. The impinged location experiences the subsequent DEF injection at temperature Z.

In another embodiment, a hydrophobic coating may be positioned on the stainless steel and/or high-thermal conductivity ceramic material DRT surface prior to impingement of DEF on the surface. As noted above, DEF is an aqueous urea solution comprising about 32.5% urea and about 67.5% water that negatively affects engine fuel economy as buildup accrues in the DRT. Hydrophobic coatings are configured to at least (1) condition the DRT surface to enable DEF droplet movement to high heat transfer areas; or (2) actively heat portions of the DRT surface (to-be-impinged with DEF) to enable the Leidenfrost effect and promote re-entrainment of the DEF back into the exhaust stream; or (3) prevent droplets from lingering on a surface, thereby reducing the localized surface temperature as in FIG. 5 due to heat transfer to the droplet and evaporation. The Leidenfrost effect is a physical phenomenon in which the DEF, in near contact with the DRT surface (which is at a significantly higher temperature than a boiling point of the DEF), produces an insulating vapor layer in between the DEF and DRT surface and keeps the DEF from boiling rapidly. The DEF droplet hovers over the DRT surface rather than making physical contact. Hydrophobicity is typically determined using conventional contact angle measurements. In one implementation, the hydrophobic coating comprises any DRT surface (either stainless steel and/or high-thermal conductivity material) that may be exposed to the DEF and which is defined with micro-features and/or nano-features thereon. In other implementations, the hydrophobic coating comprises either an inner surface of the housing of the DRT or a surface of the mixer of the DRT which includes micro-features and/or nano-features thereon. In one embodiment, the micro-features may be features having a height and width in a range of greater than 0 μm and less than 1 μm and the nano-features may be features having a height and width in a range of greater than or equal to 1 μm and less than 100 μm.

In another embodiment, an impinging surface of the stainless steel and/or high-thermal conductivity ceramic material DRT surface may be finished, polished, or buffed prior to impingement of DEF on the surface. Polishing may be conducted by, for example, at least abrasive belt grinding, abrasive wheel grinding (e.g., using a silicon carbide (SiC) wheel with 320 grit polishing apparatus), abrasive stone grinding, honing, particle blasting, wet polishing (e.g., using at least one of: a 3 μm paste and chemical clean, a 3 μm simichrome paste, a 3 or 15 μm diamond paste, a 45 μm paste, etc.) or a combination thereof. In one implementation, polishing is conducted using an extrude honing process to promote polishing, deburring, and generating radii of the DRT surface in a single step. Buffing may be conducted by, for example, at least wheel or mop buffing, sand buffing, or a combination thereof. Buffing motion may include, for example, at least cut motion, color motion, or a combination thereof to achieve a specific surface finish. Surface polishing decreases surface temperature at which the Leidenfrost effect occurs (thus initiating an insulated vapor layer at lower surface temperatures), thereby preventing the DEF from contacting the surface (as in the Leidenfrost effect), and enabling the DEF to become re-entrained at lower surface and gas temperatures. At higher degrees of surface roughness, a higher surface temperature is required to initiate the Leidenfrost effect and create the vapor layer that prevents surface-to-droplet contact. Once polished, the surface finishing has a negligible impact on Leidenfrost temperature. Moreover, surface polishing also eliminates crevices and abnormalities on the DRT surface, in which liquid DEF or urea may become trapped and accumulate over time, thereby developing into problematic deposits.

The present application discloses high thermal conductivity ceramics for use in an internal structure of a DRT that allows for sufficient transfer of heat from non-wetted regions to wetted regions in order to maintain high temperatures and prevent deposition of DEF. By purposefully maximizing heat transfer to the impinging DEF, high thermal conductivity ceramics minimize DEF deposit formation and re-entrain water droplets back into the exhaust stream to thereby maximize transfer of NH₃ to the catalyst.

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, the separation of various system components in the implementations described above should not be understood as requiring such separation in all implementations, and it should be understood that the described components and systems can generally be integrated in a single product or packaged into multiple products embodied on tangible media.

As utilized herein, the terms “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims. Additionally, it is noted that limitations in the claims should not be interpreted as constituting “means plus function” limitations under the United States patent laws in the event that the term “means” is not used therein.

The terms “coupled” and the like as used herein mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another or with the two components or the two components and any additional intermediate components being attached to one another.

The terms “fluidly coupled,” “in fluid communication,” and the like as used herein mean the two components or objects have a pathway formed between the two components or objects in which a fluid, such as water, air, gaseous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various exemplary implementations is illustrative only and not restrictive in character. All changes and modifications that come within the spirit and/or scope of the described implementations are desired to be protected. For example, while the use of this technology is exemplified for diesel particulate filter (DPF) nanofilter-augmented ceramic substrates, it should be understood that the present disclosure is not limited to this application. Rather diesel particulate filters for diesel engines are merely one embodiment meant to exemplify automotive applications. It should also be understood that some features may not be necessary and implementations lacking the various features may be contemplated as within the scope of the application, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A decomposition reactor tube (DRT) for converting a reductant into ammonia, comprising:
an inlet configured to receive exhaust gas; and
an internal structure comprising a high-thermal conductivity material having a thermal conductivity greater than 20 W/(m·K),
wherein the internal structure is at least one of a splash plate, a splash plate frame, a double wall, an outer wall, a mixer, and/or an exhaust assist port.

2. The DRT according to claim 1, wherein the high-thermal conductivity material has a thermal conductivity of at least 100 W/(m·K).

3. The DRT according to claim 1, wherein the high-thermal conductivity material has a thermal diffusivity greater than 4.7 mm²·sec⁻¹.

4. The DRT according to claim 3, wherein the high-thermal conductivity material has a thermal diffusivity of at least 50 mm²·sec⁻¹.

5. The DRT according to claim 1, wherein the high-thermal conductivity material has a yield strength of at least 300 MPa and a heat capacity of at least 700 J/kg·K.

6. The DRT according to claim 1, wherein the high-thermal conductivity material is chemically inert to diesel exhaust fluid (DEF) and urea-based compounds.

7. The DRT according to claim 1, wherein the high-thermal conductivity material comprises a ceramic material and/or a metal alloy material.

8. The DRT according to claim 1, wherein the high-thermal conductivity material comprises at least one ceramic material selected from the group consisting of silicon carbide, aluminum nitride, and/or pyrolytic graphite.

9. The DRT according to claim 1, wherein the high-thermal conductivity material comprises a metal alloy material selected from the group consisting of an aluminum alloy, a magnesium-scandium alloy, and/or an aluminum-silicon-manganese-magnesium alloy.

10. The DRT according to claim 1, wherein the internal structure is at a temperature of at least 130° C.

11. The DRT according to claim 1, wherein the internal structure includes a hydrophobic surface coating.

12. The DRT according to claim 11, wherein the hydrophobic surface coating comprises micro-features and/or nano-features on at least a portion of the internal structure of the DRT.

13. The DRT according to claim 1, wherein the internal structure is a polished internal structure, a buffed internal structure, or a combination thereof.

14. A method of using a decomposition reactor tube (DRT), comprising:
(a) injecting diesel engine fluid (DEF) into the DRT;
(b) impinging the DEF at an impinging location of an internal structure of the DRT, the impinging location being at a pre-impingement temperature and the DEF being at a first temperature less than the pre-impingement temperature;
(c) conductively transferring heat energy from the impinging location to the impinged DEF such that the DEF reaches a second temperature greater than the first temperature; and
(d) evaporating the impinged DEF from the impinging location of the DRT,
wherein the internal structure comprises a high-thermal conductivity material having a thermal conductivity greater than 20 W/(m·K).

15. The method according to claim 14, wherein the high-thermal conductivity material has a thermal conductivity of at least 100 W/(m·K).

16. The method according to claim 14, wherein the high-thermal conductivity material has a thermal diffusivity greater than 4.7 mm²·sec⁻¹.

17. The method according to claim 16, wherein the high-thermal conductivity material has a thermal diffusivity of at least 50 mm²·sec⁻¹.

18. The method according to claim 14, wherein the high-thermal conductivity material has a yield strength of at least 300 MPa and a heat capacity of at least 700 J/kg·K.

19. The method according to claim 14, wherein the high-thermal conductivity material comprises a ceramic material and/or a metal alloy material.

20. The method according to claim 14, wherein the high-thermal conductivity material comprises at least one ceramic material selected from the group consisting of silicon carbide, aluminum nitride, and/or pyrolytic graphite.

21. The method according to claim 14, wherein the high-thermal conductivity material comprises a metal alloy material selected from the group consisting of an aluminum alloy, a magnesium-scandium alloy, and/or an aluminum-silicon-manganese-magnesium alloy.

22. The method according to claim 14, further comprising:
applying a hydrophobic surface coating to the internal structure prior to the step of impinging the DEF.

23. The method according to claim 22, wherein the step of applying includes forming micro-features and/or nano-features on at least a portion of the internal structure of the DRT.

24. The method according to claim 14, further comprising:
polishing and/or buffing the internal structure prior to the step of impinging the DEF.

25. The method according to claim 14, wherein the pre-impingement temperature is at least 130° C.
